(19) United States
(12) Patent Application Publication
(10) Pub. No.: US 2026/0041110 A1
(43) Pub. Date: Feb. 12, 2026

(54) OIL-IN-WATER TYPE EMULSION COMPOSITION, PRODUCTION METHOD THEREOF AND FOOD

(71) Applicant: MIYOSHI OIL & FAT CO., LTD., Tokyo (JP)

(72) Inventor: Keisuke UOZUMI, Tokyo (JP)

(73) Assignee: MIYOSHI OIL & FAT CO., LTD., Tokyo (JP)

(21) Appl. No.: 19/150,078

(22) PCT Filed: Jan. 23, 2024
(86) PCT No.: PCT/JP2024/001788

§ 371 Date: Jul. 22, 2025

(30) Foreign Application Priority Data
Jan. 25, 2023 (JP) 2023-009383

(51) Int. Cl. A23D 7/005; A23D 7/01; A23D 7/02; A23L 29/10; A23L 29/262

(52) U.S. Cl. CPC A23D 7/0053; A23D 7/011; A23D 7/02; A23L 29/10; A23L 29/262

(57) ABSTRACT

Provided are: an oil-in-water type emulsion composition that is firm at low temperature without being not overly kneaded therein during cooking, allows food products, such as meat processed foods and meat-like processed foods, to have fatty appearance, and provides a moderate amount of dripping while maintaining the shape during heating to thereby provide an excellent texture in terms of juiciness, and imparts granulated texture of fat to improve eating quality; a method for producing the same; and a food product thereof. The oil-in-water type emulsion composition according to the present invention contains an oil/fat, a methylcellulose having a kinematic viscosity of 4,000 mm²/s or higher in a 2 mass % aqueous solution at 20° C., and an emulsification agent, wherein the oil/fat is contained therein in an amount of 63 to 85 mass %.

### TECHNICAL FIELD

The present invention relates to an oil-in-water type emulsion composition, a production method thereof, and a food using the oil-in-water type emulsion composition.

### BACKGROUND ART

Beef fat or lard is used as the fat component in processed meat products such as hamburger steaks, ham, and sausages. Beef fat or lard is a fatty meat that possesses unique and desired attributes including juiciness and an appearance of granulated texture. Their properties are not attributed by the fat itself; rather, the tissue of fat is one of the attributes for these properties and provides a moderate amount of dripping while remaining heat resistant so that it does not completely melt during heat application, and is firm at low temperature to the extent that it is not overly kneaded therein and is roughly dispersed.

Meat substitutes made of plant-based ingredients are gaining attention due to concerns about environmental issues and meat resources. Recently, in line with achieving Sustainable Development Goals (SDGs), an interest in developing truly sustainable food production systems has surged across the globe. In light of these circumstances, as a solution to the growing world population and the environmental burden associated with livestock, attention is increasing towards plant-based meat-like processed foods that use plant-based ingredients such as soy and mimic the texture of meat, such as soy hamburgers. Research has also focused on substitutes using vegetable oil as fatty meat for processed meat or meat-like food products or to enhance juiciness.

However, creating a plant-based substitute for fatty meat such as beef tallow or lard requires achieving desired attributes such as a granulated appearance, texture, and juiciness that closely resemble those of real ones.

An oil-in-water type emulsion composition that employs methylcellulose is proposed as a technique for providing a meat processed food with juiciness (Patent documents 1 and 2).

### PRIOR ART DOCUMENTS

### Patent Documents

Patent document 1: JP-A-2009-183194
Patent document 2: JP-A-2022-018929

### SUMMARY OF INVENTION

### Technical Problem

However, patent document 1 employs a low-viscosity methylcellulose, which is not designed to maintain its shape before and after being heated and cannot impart granulated textures similar to those of beef fat or lard. Additionally, it incorporates proteins such as sodium casein for emulsification, but they may negatively affect the flavor, and their impact on desired attributes as substitutes for meat fat remain uncertain-particularly in relation to the physical properties when highly viscous methylcellulose is used. Furthermore, sodium casein, being derived from animals, is unsuitable in respect of plant-based applications. A study is underway to improve the texture of meat-like, plant-based processed foods by incorporating soy protein isolate that is powdery and protein-rich, but it not only impacts the desired attributes as a substitute for meat fat but also tends to make it highly viscous, posing challenges by limiting manufacturing method options.

In patent document 2, water is added and mixed into a prepared liquid mixture containing a liquid oil/fat and methylcellulose to obtain a composition for a processed meat product. However, no emulsification agent is used so as not to create a homogeneous, emulsified state; rather, an inhomogeneous state of oil and water is formed to improve the desired attributes, and this poses challenges in stable production and presents opportunities for improvement.

The present invention has been made in view of such circumstances and it is an object of the present invention to provide an oil-in-water type emulsion composition that is firm at low temperatures without being not overly kneaded therein during cooking, allows food products, such as meat processed foods and meat-like processed foods, to have fatty appearance, and provides a moderate amount of dripping while maintaining the shape during heating, is excellent in juicy texture, and imparts granulated texture of fat to improve eating quality as well as to provide a method for producing the same and a food product thereof.

### Solution to Problem

The present inventors have made a series of studies to solve the above objects and found a knowledge that an oil-in-water type emulsion composition containing a high amount of oil/fat and having an emulsification agent may be formulated with methylcellulose that is highly viscous at room temperature and turns into a gel by application of heat to thereby provide a product that moderately drips without completely being melt by heat. Also, a methylcellulose that turns into a gel by application of heat is dispersed, in an insoluble state at high temperature, into an emulsified product having oil droplets that are uniformly and finely distributed by an emulsification agent, and the mixture is charged into a container and then cooled to solubilize the methylcellulose to thereby make it highly viscous. This process results in an oil-in-water type emulsion composition that is firm enough to the extent it is not overly kneaded therein during cooking, has heat resistive shape retainability so that it does not completely melt during heat application, provides a moderate amount of dripping during cooking, and allows meat-like fatty meat to reproduce in the form of plant-based food product, thus completing the present invention.

That is, the oil-in-water type emulsion composition according to the present invention is characterized in that it contains an oil/fat, a methylcellulose having a kinematic viscosity of 4,000 mm²/s or higher in a 2 mass % aqueous solution at 20° C., and an emulsification agent, wherein the oil/fat is contained therein in an amount of 63 to 85 mass %.

The method for producing the oil-in-water type emulsion composition according to the present invention is characterized by a method for producing the oil-in-water type emulsion composition including the steps of.
dispersing the methylcellulose in an insoluble state into an aqueous phase at 40° C. or higher in an oil-in-water type emulsion composition that is in a process of being produced;
charging the oil-in-water type emulsion composition whose methylcellulose is dispersed in the aqueous phase into a container; and
cooling the oil-in-water type emulsion composition after being charged thereinto to dissolve the methylcellulose.

The food product according to the present invention is directed to a food product that contains the oil-in-water type emulsion composition.

### Advantageous Effects of Invention

According to the oil-in-water type emulsion composition and the method for producing the same of the present invention, the oil-in-water type emulsion composition is firm at low temperatures without being not overly kneaded therein during cooking, and therefore allows food products, such as meat processed foods and meat-like processed foods, to have fatty appearance, and provides a moderate amount of dripping while maintaining the shape during heating, which therefore provides excellency in juicy texture and imparts granulated texture of fat to improve eating quality.

According to the food product of the present invention, the oil-in-water type emulsion composition allows the food product to have fatty outer appearance, and provides a moderate amount of dripping while the oil-in-water type emulsion composition maintains the shape during heating, which therefore provides excellency in juicy texture and imparts granulated texture of fat to improve eating quality.

### BRIEF DESCRIPTION OF DRAWINGS

FIG. 1A illustrates a picture of an oil-in-water type emulsion composition of Working Example 3 in a state before it is heated.

FIG. 1B illustrates a picture of an oil-in-water type emulsion composition of Working Example 3 in a state after it is heated at 60° C. for one hour.

FIG. 1C illustrates a picture of an oil-in-water type emulsion composition of Comparative Example 3 in a state after it is heated at 60° C. for one hour.

FIG. 2 illustrates pictures showing outer appearances of soy meat-based hams prepared using oil-in-water type emulsion compositions of Reference Example 4 and Working Example 13.

FIG. 3A illustrates a picture of soy patty prepared using an oil-in-water type emulsion composition of Reference Example 5 in a state of being compressed.

FIG. 3B illustrates a picture of a soy patty prepared using an oil-in-water type emulsion composition of Working Example 13 in a state of being compressed.

FIG. 4A illustrates a picture showing an outer appearance of a soy patty that is uncooked and prepared using an oil-in-water type emulsion composition of Reference Example 5.

FIG. 4B illustrates a picture showing an outer appearance of a soy patty that is uncooked and prepared using an oil-in-water type emulsion composition of Working Example 13.

FIG. 5 illustrates a picture showing a cross section of a plant-based block meat that is under refrigeration and prepared using an oil-in-water type emulsion composition of Working Example 4.

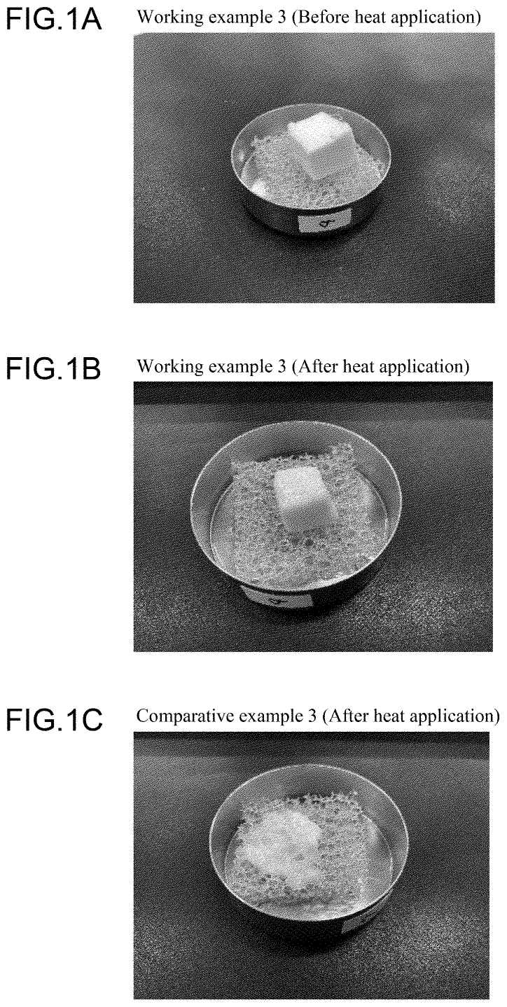

### DESCRIPTION OF EMBODIMENTS

Embodiments for carrying out the present invention will be specifically described hereinbelow. The oil-in-water type emulsion composition according to the present invention contains an oil/fat, a methylcellulose having a kinematic viscosity of 4,000 mm²/s or higher in a 2 mass % aqueous solution at 20° C., and an emulsification agent.

An edible oil/fat is normally used for the oil/fat in the oil-in-water type emulsion composition according to the present invention. An edible oil/fat is defined as a composition that consists primarily of triglycerides each consisting of three fatty acids attached via ester binding to a single glycerol molecule, and examples of such edible oil/fat include vegetable oils/fats, animal oils/fats, synthetic oils/fats, and processed oils/fats. They may be used alone or as a blended oil in combination with two or more types of them.

Examples of the vegetable oils/fats include, a palm oil, rapeseed oil, soybean oil, sunflower oil, corn oil, sesame oil, perilla oil, flaxseed oil, peanut oil, safflower oil, a high oleic safflower oil, a high oleic sunflower oil, cottonseed oil, grape seed oil, macadamia nut oil, hazelnut oil, pumpkin seed oil, walnut oil, camellia oil, tea seed oil, perilla oil, borage oil, olive oil, rice bran oil, wheat germ oil, cocoa fat, coconut oil, palm kernel oil, algae oil, and a flavor oil.

Examples of the animal oils/fats include a pork fat, a beef fat, a milkfat, a sheep fat, a fish oil, a chicken oil, and a flavored oil. Examples of the synthetic oils/fats include a medium chain fatty acid oil and diacylglycerol. The processed oils/fats may be those in which the above-listed oils/fats are subjected to desired processing. Examples of such processing include fractionation by melting points, hydrogenation, and ester exchange reaction. One or more processing may be performed on such oils/fats.

Of these, it is preferred in terms of using plant-based ingredients as substitutes for animal meats that the oil-in-water type emulsion composition according to the present invention employs at least one selected from a vegetable oil/fat and a processed oil/fat of vegetable oil/fat, it is more preferred that the composition further contain a flavored oil using these as base materials.

The oil-in-water type emulsion composition according to the present invention contains an oil/fat in an amount of 63 to 85 mass %. The oil/fat contained within this range results in a composition that is firm at low temperatures without being overly kneaded during cooking and may condition the product to provide a moderate amount of dripping while maintaining its shape during heating. Additionally, it readily allows emulsification during manufacturing. It is preferred that the amount of oil/fat contained therein be 68 mass % or more, more preferably 72 mass % or more in terms of being firm at low temperatures without being overly kneaded during cooking and allowing conditioning of the product to provide a moderate amount of dripping while maintaining its shape during heating. It is also preferred that the amount of oil/fat contained therein be 83 mass % or lower, more preferably 78 mass % or lower in terms of readily achieving emulsification during manufacturing and allowing conditioning of the product to provide a moderate amount of dripping.

It is preferred that the oil/fat of the oil-in-water type emulsion composition according to the present invention have a solid fat content at 10° C. of 10 to 90%. A solid fat content at 10° C. within this range allows the composition to be firm enough not to be overly kneaded therein during cooking, and allows conditioning to provide a moderate amount of dripping while maintaining its shape during heating. It is preferred in terms of providing more sufficient firmness that the solid fat content at 10° C. be 30% or more. It is also preferred in terms of reducing white solidification of drips that the solid fat content at 10° C. be 60% or less. The solid fat content may be determined in accordance with “2.2.9-2013 Solid Fat Content (NMR Method)” as set forth in the Standard Methods for the Analysis of Fats and Oils (Japan Oil Chemists' Society).

The term “methylcellulose”, as used in the oil-in-water emulsion composition according to the present invention, refers to a cellulose derivative synthesized by chemically modifying cellulose which is a plant fiber, and the modification involves O-methylating some of the hydroxy groups in cellulose, replacing them with methyl groups, which serves to transform water-insoluble methylcellulose into a water-soluble compound. The methylcellulose dissolved in water exhibits properties in which the methylcellulose forms a gel as it heats up to a temperature above the gelation temperature, while it returns to an aqueous solution, causing the gel to disappear, as it cools down to a temperature below the gelation temperature.

According to the oil-in-water type emulsion composition of the present invention, the methylcellulose has a kinematic viscosity of 4,000 mm²/s or higher in a 2 mass % aqueous solution at 20° C. A kinematic viscosity of 4,000 mm²/s or higher results in an oil-in-water type emulsion composition that is firm enough not to be overly kneaded therein during cooking at low temperatures, has heat resistive shape retainability so that it does not completely melt during heat application by which it forms a gel, and provide a moderate amount of dripping during heat application, and it also allows meat-like fatty meat to reproduce in the form of plant-based food product. The kinematic viscosity may be 7,000 mm²/s or higher, 10,000 mm²/s or higher, 50,000 mm²/s or higher, or 80,000 mm²/s or higher. The kinematic viscosity may have any upper limit which is not particularly limited but it is, for example, 150,000 mm²/s or less.

The kinematic viscosity of methylcellulose at 20° C. in a 2 mass % aqueous solution may be determined by a method as set forth in “methylcellulose” in Japan's Specifications and Standards for Food Additives, 9th edition.

Methylcellulose is an approved food additive and a methylcellulose having a kinematic viscosity, at 20° C. in a 2 mass % aqueous solution, of 4,000 mm²/s or higher is commercially available.

It is preferred that the oil-in-water type emulsion composition of the present invention contain methylcellulose in an amount of 0.5 to 10 mass %, more preferably of 1.5 to 7.0 mass %, and even more preferably of 1.5 to 5.0 mass %. An amount of methylcellulose contained therein within this range is suitable for delivering the above advantageous effects to be brought by adding methylcellulose.

The oil-in-water type emulsion composition according to present invention may employ any emulsification agent which is not particularly limited but it is preferred that the agent be a non-ionic emulsification agent in respect of: dispersing methylcellulose, which forms a gel through heat, in an insoluble state at high temperatures, into an emulsified product in which oil droplets are uniformly and finely dispersed by the emulsification agent; and charging it into a container and then cooling the same to dissolve the methylcellulose to make it highly viscous to thereby allow the emulsified product in which oil droplets are uniformly and finely dispersed to provide the oil-in-water type emulsion composition with firmness to the extent it does not overly kneaded during cooking and heat resistive shape retainability so that it does not completely melt during heat application while providing a moderate amount of dripping during heat application. It is preferred that the non-ionic emulsification agent be a synthetic emulsification agent, more preferably a fatty acid ester. The use of proteins raises concerns regarding the effectiveness of the present invention.

Examples of the emulsification agents include a sorbitan fatty acid ester, a monoglycerin fatty acid ester (such as monoglycerin monopalmitate ester and monoglycerin monostearate ester), a diglycerin fatty acid ester, a polyglycerin fatty acid ester, a sucrose fatty acid ester, a glycerin organic acid fatty acid ester (such as diacetyltartaric acid monoglyceride, succinic acid monoglyceride, citrate monoglyceride, and lactate monoglyceride), a polyglycerin condensed ricinoleic acid ester, a propylene glycol fatty acid ester, a polyoxyethylene sorbitan fatty acid ester, lecithin, and lysolecithin. They may be used alone or two or more of them may be used in combination.

It is preferred that the emulsification agent be at least one selected from a sorbitan fatty acid ester, a monoglycerin fatty acid ester, a polyglycerin fatty acid ester, and a sucrose fatty acid ester, and it is more preferred that two or more of them be combined.

The emulsification agent may have any HLB which is not particularly limited, and examples of which include those in a range of 3 to 16. The value of HLB may be determined in accordance with the method of Griffin (by the method of ATLAS Powder company). The agent may be added in the oil phase for use when it is oleophilic or in the aqueous phase for use when it is hydrophilic.

It is preferred that the oil-in-water type emulsion composition of the present invention contain an emulsification agent in an amount of 1 to 5 mass %, more preferably of 2 to 4 mass %. An amount of the emulsification agent contained therein within this range is suitable for delivering the above advantageous effects to be brought by the emulsification agent.

When a fatty acid ester is used as an emulsification agent, the emulsification agent may contain 80 mass %, 85 mass %, 90 mass %, or 95 mass % of fatty acid ester relative to its total composition of the emulsification agent.

In the oil-in-water type emulsion product of the present invention, it is preferred that the weight ratio of methylcellulose to the emulsification agent be 0.1 to 3.5, more preferably 0.3 to 2.0. The content of methylcellulose to the emulsification agent within this range is suitable for delivering a suitable effect of drips.

The oil-in-water type emulsion composition according to the present invention may contain a further component not mentioned in the above components so long as it does not impair the advantageous effects of the present invention. Examples of such further component include, but are not particularly limited to, a methylcellulose having a kinematic viscosity of less than 4,000 mm²/s in a 2 mass % aqueous solution at 20° C., starch, carbohydrates, dietary fiber, grain flour, gelling agents, thickeners, seasonings, yeast extracts, salts, spices, coloring agents, and fragrances.

A methylcellulose having a kinematic viscosity of less than 4,000 mm²/s in a 2 mass % aqueous solution at 20° C. or one having a kinematic viscosity of less than 1,000 mm²/s in a 2 mass % aqueous solution at 20° C. may be concurrently used therewith for the sake of readily controlling the amount of drips.

The oil-in-water type emulsion composition according to the present invention is produced by preparing an oil phase, containing a fat/oil, and an aqueous phase, and then subjecting them to an emulsification step. Any method may be used for emulsification, and examples of which include a method by which it is subjected to a preliminary emulsification and then subjected to homogenization.

In the step of preliminary emulsification, a homo mixer or other machine may be used to mix the oil and aqueous phases to roughly disperse droplets of oil in the aqueous phase before being subjected to homogenization treatment using a homogenizer such as a high-pressure homogenizer. Into the oil phase is added not only an oil/fat but also an emulsification agent when the emulsification agent to be used is oleophilic, whereas the emulsification agent is added into the aqueous phase when the emulsification agent to be used is hydrophilic.

During the preliminary emulsification step, the oil phase may be heated to a temperature at which the oil/fat fully melts, while the aqueous phase may be warmed to a temperature that prevents lowering of temperature of the mixed oil phase, thereby allowing the oil and aqueous phases to be mixed, preferably at 55 to 85° C., and more preferably at 60 to 80° C. The emulsified product, after undergoing the preliminary emulsification step, may be subjected to defoaming under reduced pressure.

A homogenizer such as a high-pressure homogenizer may be used for performing homogenization under the conditions of, for example, pressures that have been conventionally used for producing the oil-in-water type emulsion composition, and such pressures may be suitably set within a range of, for example, 0 to 100 MPa. The median diameter of oil droplets may be controlled through this step of homogenization. In addition, thermal sterilization may be conducted as a step to be carried out either before or after the homogenization treatment; alternatively, the thermal sterilization may be performed after performing the homogenization treatment, and subsequently the homogenization treatment may be performed once more. It is preferred in terms of efficiency in, for example, homogenization treatment that the emulsified product have a liquid temperature, during the homogenization treatment, of 50 to 80° C., more preferably of 60 to 70° C.

It is preferred that the oil-in-water type emulsion composition of the present invention be produced by the steps of: (A) dispersing methylcellulose, as a process of adding the methylcellulose, in an insoluble state into an aqueous phase at a temperature greater than or equal to a predefined temperature in an oil-in-water type emulsion composition that is in a process of being produced; (B) charging the oil-in-water type emulsion composition whose methylcellulose is dispersed in the aqueous phase into a container; and (C) cooling the oil-in-water type emulsion composition after being charged thereinto to dissolve the methylcellulose. The methylcellulose may be put thereinto at any time either before or after the emulsification step so long as it has a temperature greater than or equal to the predefined temperature.

The methylcellulose dissolved in water exhibits properties in which the methylcellulose forms a gel as it heats up to a temperature above the gelation temperature, while it returns to an aqueous solution, causing the gel to disappear, as it cools down to a temperature below the gelation temperature. A process of dispersing the methylcellulose in an insoluble state into an aqueous phase at or above the gelation temperature enables the emulsification agent to produce an emulsified product with uniform and fine oil droplets without becoming highly viscous. After that, the oil-in-water type emulsion composition is charged into a container and is cooled to dissolve the methylcellulose to thereby allow the methylcellulose to have a temperature at or below the gelation temperature and to be highly viscous while maintaining the emulsified product to have uniform and fine oil droplets by means of the emulsifying agent. This feature produces an oil-in-water type emulsion composition that is firm enough not to be overly kneaded therein at low temperatures during cooking, has heat-resistive shape retainability so that it does not completely melt during heat application, and provides a moderate amount of dripping during heat application, and it also allows meat-like fatty meat to reproduce in the form of plant-based food product.

It is preferred that the aqueous phase in the step (A) have a temperature at which the methylcellulose exhibits a temperature above the gelation temperature, more preferably at 40° C. or higher, and even more preferably at 50° C. or higher, and most preferably at 60° C. or higher. The term “insoluble state” refers to a condition where the added methylcellulose remains insolubilized in the aqueous phase, either at least partially or, preferably, entirely.

Any container which is not particularly limited may be used for charging the oil-in-water type emulsion composition in the step (B), and a can or cardboard having a pouch or an inner bag may be used for industrial production.

The oil-in-water type emulsion composition may be cooled in the step (C) to any temperature which is not particularly limited but it is preferred that the temperature be 0 to 10° C. It is preferred that the oil-in-water type emulsion composition be cooled for the period of 12 to 72 hours although this period is not particularly limited.

It is preferred that the oil-in-water type emulsion composition of the present invention have a median diameter of 1.0 to 4.0 μm, more preferably of 2.0 to 3.5 μm. A median diameter within this range allows the emulsified product whose droplets of oil are finely dispersed to produce an oil-in-water type emulsion composition that has firmness to the extent it is not overly kneaded therein during cooking, and provides a moderate amount of dripping during heat application.

The median diameter as used herein refers to a value measured during the production process of the oil-in-water type emulsion composition before the step (C) of cooling the oil-in-water type emulsion composition to dissolve the methylcellulose; for example, it refers to a value measured during the step (B) of charging the oil-in-water type emulsion composition whose methylcellulose is dispersed in the aqueous phase into a container; a value measured during the step (A) of dispersing methylcellulose in an insoluble state; or a value of the oil-in-water type emulsion composition measured before adding methylcellulose.

The median diameter may be calculated based on the particle size distribution of oil droplets in the oil-in-water type emulsion composition which is measured by laser diffractometry. This median diameter is measured on the volume basis using a particle size distribution analyzer such as SALD-2300 wet laser diffraction particle size analyzer manufactured by SHIMADZU CORPORATION.

The oil-in-water type emulsion composition according to the present invention exhibits plasticity. The term “plasticity” as used herein refers to the property to be deformed by an external force without reverting to the original form at low to room temperatures. The oil-in-water type emulsion product exhibits plasticity when it contains a high amount of oil/fat and is formulated with the above-mentioned methylcellulose. The oil-in-water type emulsion composition of the present invention having the plasticity exhibits firmness at low temperature, which allows it to be readily shaped into small pieces such as into minced meats. This feature allows dispersion without being not overly kneaded therein during cooking, allows food products, such as meat processed foods and meat-like processed foods, to have the fatty appearance, and provides a moderate amount of dripping while maintaining the shape during heat application, which therefore provides excellency in juicy texture and imparts granulated texture of fat to improve eating quality.

The oil-in-water type emulsion composition of the present invention may be blended for use in a food product. According to the food product of the present invention, the oil-in-water type emulsion composition allows the food product to have the fatty appearance, and provides a moderate amount of dripping while the oil-in-water type emulsion composition maintains the shape during heat application, which therefore provides excellency in juicy texture and imparts granulated texture of fat to improve eating quality.

Examples of such food product include, but are not particularly limited to, meat processed foods and meat-like processed foods. Of these, the composition is ideal for plant-based meat-like products as it accommodates the use of vegetable oils/fats.

The meat-like processed food contains the oil-in-water type emulsion composition of the present invention and a vegetable protein ingredient. The vegetable protein ingredient serves as a substitute for animal meat, and it is preferred that the protein be contained in an amount of 40 mass % or higher, more preferably of 50 mass % or higher, based on the dry mass. Specific examples thereof include ingredients whose concentrations of protein are enhanced by processing: beans such as soybean, broad bean, peas, mung bean, chickpeas, peanut, lupinus, pigeon pea, jack bean, wild soybean, kidney bean, adzuki bean, cowpea, lentils, locust bean, red kidney bean, and black bean; grains such as wheat, oats, barley, rye, rice, and corn; vegetables such as spinach, asparagus, broccoli, kale, and cranberry; and tubers such as potato and sweet potato. Of these, it is preferable to use at least one of soybean-derived vegetable protein, pea-derived vegetable protein, and wheat-derived vegetable protein. Known examples of the soybean-derived vegetable protein ingredient include defatted soy, defatted soy flour that is a processed product originated from the defatted soy, soy protein concentrate, and soy protein isolate. These can be processed into powdered, textured, or fibrous forms, or further made into curd of powdered soy protein for use in meat-like processed food.

When the meat-like processed food is produced, the oil-in-water type emulsion composition of the present invention is kneaded with a vegetable protein ingredient to create dough or a starter, and this starter is then molded into a predetermined shape to produce a shaped product. Here, according to the present invention, the oil-in-water type emulsion composition is firm at low temperatures without being not overly kneaded therein during cooking, which therefore allows food products to have fatty appearance. This shaped product may then be heated and cooked to produce a meat-like processed food.

The meat-like processed food may be formulated with a further ingredient necessary for the intended food product so long as it does not impair the advantageous effects of the present invention. Examples of such further ingredient include, but are not particularly limited to, water, vegetables, seasonings, cereal flour, starches, dietary fiber, polysaccharide thickener, carbohydrates, salts, yeast, yeast extracts, spices, coloring agents, preservatives, and fragrances.

The meat-like processed food may be formulated with transglutaminase as a pharmaceutical preparation which serves to enhance the binding and cohesion of meat-like processed food. The transglutaminase is a type of enzyme which is essential for constructing the living body and serves to promote binding between proteins. This binding enhances cohesiveness in the meat-like processed food and forms a stable gel. The oil-in-water type emulsion composition of the present invention, even if it is formulated therein, does not impair cohesiveness or firmness brought by the enzyme reaction of transglutaminase.

It is preferred that the meat-like processed food does not substantially contain any animal-based ingredients (such as meat, meat-derived components, animal oils/fats, milk components, and egg). It is preferred that the amount of animal-based ingredients contained therein be 5.0 mass % or less, more preferably 3.0 mass % or less, even more preferably 1.0 mass % or less, and most preferably 0 mass %.

Examples of the meat-like processed food include, but are not particularly limited to, tofu patty, vegetable protein processed foods (patty-like foods, shumai-like foods, gyoza-like foods, Chinese bun-like foods, fillet meat-like foods (grilled meat, stir-fried foods), fried chicken-like foods, bacon-like foods, crab cake-like foods, pasta sauce, keema curry, sausage-like foods, meatball-like foods, tsukune meatball-like foods, nuggets-like foods, ham-like foods, meatloaf-like foods, Fleischkase-like foods, tuna flake-like foods, salami-like foods, minced meat-like foods, cutlet-like foods), and soups.

Examples of the meat processed food include, but are not particularly limited to, patty, shumai, gyoza, Chinese buns, fried chicken, pasta sauces, keema curry, sausages, Fleischkase, meatballs, tsukune, chicken nuggets, ham, salami, minced meat, and soups.

It is preferred that the amount of the oil-in-water type emulsion composition of the present invention contained in a food such as meat-like processed food or meat processed food be 2 to 15 mass %, more preferably 5 to 10 mass %, based on the whole mass of the food.

### EXAMPLES

The present invention will be described in greater detail hereunder with reference to working examples; the invention shall not be limited to the following working examples. Here, the content amounts shown in the tables refer to values expressed as % by mass.

### 1. Preparation of Oil-In-Water Type Emulsion Composition

The emulsification agent was added, in accordance with the formulations shown in Tables 1A, 1B, and 2, to either water or oil in which it was soluble on the basis of its HLB, and the temperature was adjusted to 70° C. or higher to form the water phase and the oil phase. The isolated soy protein was added to the water phase in which it was soluble. The oil phase was gradually poured into the aqueous phase while stirring the mixture at 70° C. and 6,000 rpm using a homo mixer to prepare an oil-in-water type emulsion product.

The emulsion product was confirmed to be at 70° C. or higher, and methylcellulose was then added, and the mixture was stirred for 20 minutes at 10,000 rpm and 80° C. to prepare a uniform oil-in-water emulsion product. Methylcellulose A, used alongside Methylcellulose D, was preliminary added for controlling the amount of drip into the aqueous phase having a temperature lower than or equal to 30° C. which is the dissolution temperature. The resultant emulsified product was charged into a container, stored at 5° C. for one day, and cooled to serve it as a sample.

The oil/fat as shown in Tables 1A and 1B used a blend oil consisting of 50 mass % of palm oil, 30 mass % of Ester exchange oil/fat 1, and 20 mass % of rape seed oil. The oil/fat as shown in Table 2 used a blend oil having contents as shown in the table. Further, the oil/fats in Tables 1A and 1B had a solid fat content (% at 10° C.) of 31.0%.

The ingredients of ester exchange oils/fats used in Tables 1A, 1B, and 2 are as listed below.

Ester exchange oil/fat 1: Palm fraction soft oil

Ester exchange oil/fat 2: Palm kernel oil/Palm kernel extremely hardened oil/Palm oil

The methylcelluloses used in Tables 1A, 1B, and 2 are as listed below.

### Methylcellulose A

METOLOSE MCE-100 (manufactured by Shin-Etsu Chemical Co., Ltd.) with a kinematic viscosity of 100 mm²/s in 2 mass % aqueous solution at 20° C.

### Methylcellulose B

METOLOSE MCE-1500 (manufactured by Shin-Etsu Chemical Co., Ltd.) with a kinematic viscosity of 1,500 mm²/s in 2 mass % aqueous solution at 20° C.

### Methylcellulose C

METOLOSE MCE-4000 (manufactured by Shin-Etsu Chemical Co., Ltd.) with a kinematic viscosity of 4,000 mm²/s in 2 mass % aqueous solution at 20° C.

### Methylcellulose D

METOLOSE MCE-100TS (manufactured by Shin-Etsu Chemical Co., Ltd.) with a kinematic viscosity of 110,000 mm²/s in 2 mass % aqueous solution at 20° C.

SOLPEA6000H (manufactured by Nisshin OilliO Group, Ltd) was used as an isolated soy protein.

### (Median Diameter)

The median diameter of the oil-in-water emulsion composition was measured using samples taken prior to cooling at 5° C. during production of the oil-in-water emulsion composition as shown above. A laser diffraction particle size analyzer (SALD-2300 manufactured by SHIMADZU CORPORATION) was used to measure the median diameter.

### 2. Evaluation

### (1) Firmness, Shape Retainability During Heating, Drips

### [Firmness]

Oil-in-water type emulsion compositions of the working and comparative examples were placed into cylindrical containers and stored for one day at 5° C., and then were cut using a spatula to smooth the surface. The temperature was adjusted at 15° C. overnight and their firmness at that time were measured using a penetrometer. The tip of the circular cone adapter, as outlined in the AOCS Official Method Cc 16-60, was positioned to touch the sample's surface. It was then dropped for 5 seconds to measure the penetration distance (mm). This value multiplied by 10 was defined as the penetration value which was evaluated based on the criteria in which:
⊚+ was assigned for the penetration value of less than 35;
⊚ was assigned for the penetration value of 35 or more and less than 50;
∘ was assigned for the penetration value of 50 or more and less than 60; and
× was assigned for the penetration value of 60 or more.

### [Shape Retainability During Heating]

The oil-in-water type emulsion compositions of the working and comparative examples were each cut out into 2 cm by 2 cm cubes, and heated at 60° C. for 1 hour after which the shapes were evaluated using the following criteria. The states of Working Example 3 after and prior to the heating and the states of Comparative Example 3 after the heating are shown as references in Tables 1A to 1C.
∘: Shapes were maintained after heating
×: They were melted without having any shape retainability

### [Drip]

The oil-in-water type emulsion compositions of the working and comparative examples were each minced using a mincer having plate holes of 5 mm diameter to form minced products which were served as samples.

5 g of the sample was placed on a sponge in a container to allow the sample to be separated from the drip, and then heated at 60° C. for 1 hour. The amount of oil/fat leaked after being heated was calculated based on the weight difference of the container, and the amount of drip per sample was determined as “drip %”.

Fatty meat of the pork rump (Reference Example 1) was also minced in a manner as shown above to set up the standard of drip % during heating, and the amounts of leaked oil/fat were evaluated using the following criteria indicated in which:
⊚++ was assigned for a value within ±5% of the standard value;
⊚+ was assigned for a value from −10% to less than −5% or from above +5% to +10% of the standard value;
⊚ was assigned for a value from −20% to less than −10% or from above +10% to +20% of the standard value;
∘ was assigned for a value from −25% to less than −20% or from above +20% to +25% of the standard value; and
× was assigned for a value less than −25% or above +25% of the standard value.

The results of the above evaluation are as shown in Tables 1A, 1B, and 2.

TABLE 1A

| | Working | Working | Working | Working | Working | Working |
|---|---|---|---|---|---|---|
| | example | example | example | example | example | example |
| | 1 | 2 | 3 | 4 | 5 | 6 |
| Oil content | 65 | 70 | 75 | 80 | 85 | 75 |
| Methylcellulose A | | | | | | |
| Methylcellulose B | | | | | | |
| Methylcellulose C | | | | | | |
| Methylcellulose D | 1.5 | 1.5 | 1.5 | 1.5 | 1.5 | 1 |
| Sorbitan fatty acid ester (HLB 5) | 2.7 | 2.7 | 2.7 | 2.7 | 2.7 | 2.7 |
| Monoglycerin fatty acid ester (HLB 4) | 0.3 | 0.3 | 0.3 | 0.3 | 0.3 | 0.3 |
| Polyglycerol fatty acid esters (HLB 6) | | | | | | |
| Polyglycerol fatty acid esters (HLB 14) | | | | | | |
| Sucrose fatty acid esters (HLB 11) | | | | | | |
| Soy protein isolate | | | | | | |
| Water | 30.5 | 25.5 | 20.5 | 15.5 | 10.5 | 21 |
| Total | 100 | 100 | 100 | 100 | 100 | 100 |
| Median diameter (μm) | 3.8 | 3.2 | 2.8 | 2.8 | 2.6 | 3.5 |
| Amount of methylcellulose / amount | 0.50 | 0.50 | 0.50 | 0.50 | 0.50 | 0.33 |
| of emulsification agent | | | | | | |
| Firmness | ◯ | ◯ | ⊚ + | ⊚ + | ⊚ + | ⊚ |
| Shape retainability during heat | ◯ | ◯ | ◯ | ◯ | ◯ | ◯ |
| application | | | | | | |
| Drip % | ◯ | ⊚ | ⊚ + | ⊚ | ◯ | ⊚ + |
| | Working | Working | Working | Working | Working | Working |
| | example | example | example | example | example | example |
| | 7 | 8 | 9 | 10 | 11 | 12 |
| Oil content | 75 | 75 | 65 | 75 | 75 | 75 |
| Methylcellulose A | | | | | 0.3 | 0.3 |
| Methylcellulose B | | | | | | |
| Methylcellulose C | | | | 1.5 | | |
| Methylcellulose D | 2 | 5 | 10 | | 1.5 | 1.5 |
| Sorbitan fatty acid ester (HLB 5) | 2.7 | 2.7 | 2.7 | 2.7 | 2.7 | 1.5 |
| Monoglycerin fatty acid ester (HLB 4) | 0.3 | 0.3 | 0.3 | 0.3 | 0.3 | |
| Polyglycerol fatty acid esters (HLB 6) | | | | | | 1.2 |
| Polyglycerol fatty acid esters (HLB 14) | | | | | | |
| Sucrose fatty acid esters (HLB 11) | | | | | | |
| Soy protein isolate | | | | | | |
| Water | 20 | 17 | 22 | 20.5 | 20.2 | 20.5 |
| Total | 100 | 100 | 100 | 100 | 100 | 100 |
| Median diameter (μm) | 2.9 | 3.0 | 3.1 | 3.5 | 3.4 | 2.4 |
| Amount of methylcellulose / amount | 0.67 | 1.67 | 3.33 | 0.50 | 0.60 | 0.67 |
| of emulsification agent | | | | | | |
| Firmness | ⊚ + | ⊚ + | ⊚ + | ◯ | ⊚ + | ⊚ + |
| Shape retainability during heat | ◯ | ◯ | ◯ | ◯ | ◯ | ◯ |
| application | | | | | | |
| Drip % | ⊚ ++ | ⊚ ++ | ⊚ + | ⊚ + | ⊚ ++ | ⊚ + |

TABLE 1B

| | Working | Working | Working | Comparative | Comparative | Comparative |
|---|---|---|---|---|---|---|
| | example | example | example | example | example | example |
| | 13 | 14 | 15 | 1 | 2 | 3 |
| Oil content | 75 | 75 | 75 | 60 | 90 | 75 |
| Methylcellulose A | 0.3 | 0.3 | 0.3 | | | |
| Methylcellulose B | | | | | | |
| Methylcellulose C | | | | | | |
| Methylcellulose D | 1.5 | 1.5 | 1.5 | 1.5 | 1.5 | 0 |
| Sorbitan fatty acid ester (HLB 5) | 1.5 | 1.5 | | 2.7 | 2.7 | 2.7 |
| Monoglycerin fatty acid ester (HLB 4) | 0.3 | 0.3 | | 0.3 | 0.3 | 0.3 |
| Polyglycerol fatty acid esters (HLB 6) | 1.2 | | | | | |
| Polyglycerol fatty acid esters (HLB 14) | | | 3.0 | | | |
| Sucrose fatty acid esters (HLB 11) | | 1.2 | | | | |
| Soy protein isolate | | | | | | |
| Water | 20.2 | 20.2 | 20.2 | 35.5 | 5.5 | 22 |
| Total | 100 | 100 | 100 | 100 | 100 | 100 |
| Median diameter (μm) | 2.2 | 2.9 | 2.5 | 6.7 | Emulsi- | 5.3 |
| | | | | | fication | |
| | | | | | failed | |
| Amount of methylcellulose / amount | 0.60 | 0.60 | 0.60 | 0.50 | 0.50 | 0.00 |
| of emulsification agent | | | | | | |
| Firmness | ⊚ + | ⊚ + | ⊚ | x | — | x |
| Shape retainability during heat | ◯ | ◯ | ◯ | ◯ | — | x |
| application | | | | | | |
| Drip % | ⊚ ++ | ⊚ + | ⊚ + | x | — | ⊚ |

| | Comparative | Comparative | Comparative | Comparative | Reference |
|---|---|---|---|---|---|
| | example | example | example | example | example 1 |
| | 4 | 5 | 6 | 7 | (Lard) |
| Oil content | 75 | 75 | 75 | 75 | |
| Methylcellulose A | 1.5 | | | | |
| Methylcellulose B | | 1.5 | | | |
| Methylcellulose C | | | | | |
| Methylcellulose D | | | 1.5 | 1.5 | |
| Sorbitan fatty acid ester (HLB 5) | 2.7 | 2.7 | 0 | 0 | |
| Monoglycerin fatty acid ester (HLB 4) | 0.3 | 0.3 | 0 | 0 | |
| Polyglycerol fatty acid esters (HLB 6) | | | 0 | 0 | |
| Polyglycerol fatty acid esters (HLB 14) | | | | | |
| Sucrose fatty acid esters (HLB 11) | | | 0 | 0 | |
| Soy protein isolate | | | | 2 | |
| Water | 20.5 | 20.5 | 23.5 | 21.5 | |
| Total | 100 | 100 | 100 | 100 | |
| Median diameter (μm) | 3.3 | 3.2 | Emulsi- | Unable to | |
| | | | fication | produce | |
| | | | failed | due to high | |
| | | | | viscosity | |
| Amount of methylcellulose / amount | 0.50 | 0.50 | — | — | |
| of emulsification agent | | | | | |
| Firmness | x | x | — | — | — |
| Shape retainability during heat | ◯ | ◯ | — | — | — |
| application | | | | | |
| Drip % | ⊚ | ⊚ + | — | — | 44.5 |

TABLE 2

| | | Working | Working | Working | Working | Working |
|---|---|---|---|---|---|---|
| | | example 13 | example 16 | example 17 | example 18 | example 19 |
| Contents | Palm oil | 50 | | | 100 | |
| of oils/ | Canola oil | 20 | 45 | 65 | | |
| fats | Ester exchange oil 1 | 30 | 30 | 15 | | |
| | Ester exchange oil 2 | | 20 | 15 | | |
| | Coconut oil | | | | | 100 |
| | Extremely hardened rapeseed oil | | 5 | 5 | | |

| | | | | | |
|---|---|---|---|---|---|
| Oil content | 75 | 75 | 75 | 75 | 75 |
| Methylcellulose A | 0.3 | 0.3 | 0.3 | 0.3 | 0.3 |
| Methylcellulose D | 1.5 | 1.5 | 1.5 | 1.5 | 1.5 |
| Sorbitan fatty acid ester (HLB 5) | 1.5 | 1.5 | 1.5 | 1.5 | 1.5 |
| Monoglycerin fatty acid ester (HLB 4) | 0.3 | 0.3 | 0.3 | 0.3 | 0.3 |
| Polyglycerol fatty acid esters (HLB 6) | 1.2 | 1.2 | 1.2 | 1.2 | 1.2 |
| Water | 20.2 | 20.2 | 20.2 | 20.2 | 20.2 |
| Total | 100 | 100 | 100 | 100 | 100 |
| Median diameter (μm) | 2.2 | 2.3 | 2.5 | 2.2 | 2.5 |
| Methylcellulose amount/Emulsifier amount | 0.6 | 0.6 | 0.6 | 0.6 | 0.6 |
| Solid fat content of oils/fats (%, 10° C.) | 31.0 | 32.7 | 22.2 | 53.3 | 81 |
| Firmness | ⊚ + | ⊚ + | ◯ | ⊚ + | ⊚ + |
| Shape retainability during heat application | ◯ | ◯ | ◯ | ◯ | ◯ |
| Drip % | ⊚ + + | ⊚ + + | ⊚ + + | ⊚ + | ⊚ + + |

(2) Temperature of Methylcellulose when it was Added Therein

Temperatures of the emulsion products having the formulation same as Working Example 13 when the methylcellulose was added were evaluated. The viscosities thereof when it was added at the temperature were measured using a vibro viscometer (model SV-10 manufactured by A&D Company, Limited). The results are as shown in Table 3.

Reference Example 3 employed a normal procedure of dissolving methylcellulose in an aqueous phase of cold water, and the product became highly viscous at the moment methylcellulose was solubilized and was impossible to produce.

TABLE 3

| | Working | Working | Working | Working | Working | Reference | Reference |
|---|---|---|---|---|---|---|---|
| | example | example | example | example | example | example | example |
| | 20 | 21 | 22 | 23 | 24 | 2 | 3 |
| Temperature of | 40 | 50 | 60 | 70 | 80 | 30 | 5 |
| methylcellulose when | | | | | | | |
| added (° C.) | | | | | | | |
| Viscosity of emulsion | 1850 | 1330 | 1170 | 1100 | 1060 | 7680(Failed | Failed |
| (mPa · s) | | | | | | to produce) | to produce |

### (3) Evaluation of Soybean Meat Ham

A soybean meat ham formulated with the oil-in-water type emulsion composition was prepared and its juiciness and the spread of meat fat across the cross section were evaluated.

The oil-in-water type emulsion compositions of the working and comparative examples were minced in advance using a mincer having 5 mm diameter outlet ports, and a hydrated textured soybean protein was defibrated using a food processor. 35 g of soy protein isolate, 20 g of processed starch, and 168 g of water were thoroughly stirred using a food processor. 130 g of the defibrated textured soybean protein and 7 g of seasoning were added thereinto and they were mixed until it became uniform. Finally, 40 g of the minced oil-in-water type emulsion composition of any one of the working and comparative examples was added and stirred to disperse them to make a dough. The dough was then loaded into a container and baked at 120° C. for 50 minutes. It was stored under refrigeration overtight and later sliced into a 1 cm-wide portion for evaluation.

Reference Example 4 employed shortening in place of the oil-in-water type emulsion composition of the working or comparative example and was used as a reference for evaluating them.

### [Juiciness]

The juiciness (oily texture) during the tasting process was evaluated through sensory analysis using Reference Example 4 as a benchmark.

Ten panelists assessed the intensity of the oily texture using a seven-point scale, from −3 to +3, with Reference Example 4 serving as the neutral benchmark (0), and the average score of them was then calculated and evaluated based on the criteria as specified below.

Taste identification test of the five tastes (sweetness, sourness, saltiness, bitterness, and umami), identification test of the taste concentration difference, identification test of the food taste, and standard olfactory test were carried out by panelists of which 6 men and 4 women in his/her 20s and 50s were elected as the panelists determined as suitable by the respective tests.
⊚ was assigned for an average score of 1.5 or more.
∘ was assigned for an average score of 0.7 or more and less than 1.5
× was assigned for an average score of 0.7 or less.

### [Spread of Meat Fat Across Cross Section]

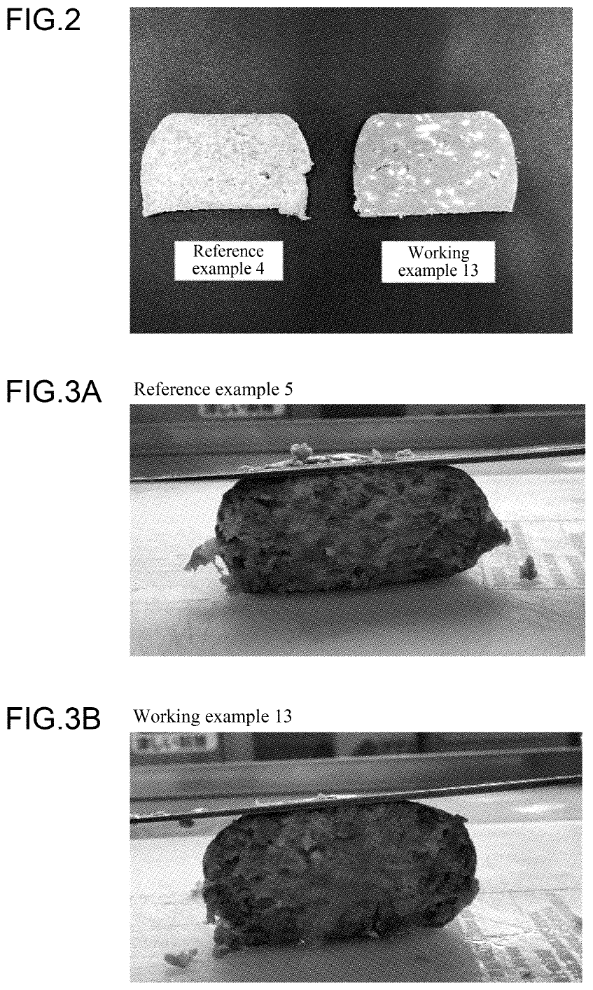

The standard as indicated below was used to evaluate whether the meat fat was well distributed and the product had an outer appearance (physical appearance) similar to salami. FIG. 2 illustrates outer appearances, as references, of soy meat-based hams of Reference Example 4 and Working Example 13.
∘ was assigned for a meat fat that was well spread and provided an outer appearance of salami.
× was assigned for a meat fat that was kneaded in dough and unable to visually confirm the spread of meat fat.

The results of the above evaluation are as shown in Table 4.

TABLE 4

| | Working | Comparative | Comparative | Reference |
|---|---|---|---|---|
| | example 13 | example 1 | example 4 | example 4 |
| Juiciness | ⊚ | X | X | — |
| Texture across | ◯ | X | X | X |
| cross section | | | | |

### (4) Evaluation of Soy Meat Patty

Soy meat patty formulated with the oil-in-water type emulsion composition were prepared to evaluate their juiciness, firmness, and appearance before thermal processing.

The oil-in-water type emulsion compositions of the working and comparative examples were each minced using a mincer having 5 mm diameter outlet ports to form minced products. 108 g of hydrated textured soybean protein, 110 g of soybean card, and 34.5 g of other food ingredients were added and thoroughly kneaded until it stuck, and finally, 30 g of the minced oil-in-water type emulsion compositions of the working and comparative examples were mixed to spread them to make a dough. The dough was formed into 80 g portions, which were thermally processed for 15 minutes by a convention oven set at 180° C.

Reference Example 5 employed rape seed oil in place of the one of the working or comparative examples and was used as a reference for evaluating them.

### [Juiciness]

A patty immediately after being thermally processed was cut in half at the center portion of it, and then the meat juiciness of the patty at the time of compression was determined using the criteria as indicated below. FIGS. 3A and 3B illustrate, as references, the states of soy patty of Reference Example 5 and Working Example 13 when they were compressed. Note that the grades of ∘ or higher are regarded as those capable of solving the inventive object.
⊚ was assigned when the meat juices significantly seeped out.
∘ as assigned when the meat juices moderately seeped out.
Δ was assigned when the meat juices slightly seeped out.
× was assigned when the meat juices seeped out to a level equal to or lower than the reference example.

### [Firmness]

A texture analyzer of EZ-SX200N (manufactured by Shimadzu Corporation) was used for the measurement. A patty whose temperature was controlled at 60° C. was compressed by 50% at the center using a 20 mm diameter cylindrical jig, and the load (N) was measured under the condition of 1 mm/sec and evaluated using the criteria as indicated below. Note that the grades of ∘ or higher are regarded as those capable of solving the inventive object.
⊚ was assigned when a force of 18 N or higher was applied during compression.
∘ was assigned when a force of 15 N or higher and lower than 18 N was applied during compression.
Δ was assigned when a force of 13 N or higher and lower than 15 N was applied during compression.
× was assigned when a force of lower 13 N was applied during compression.

### [Outer Appearance Before Thermal Processing]

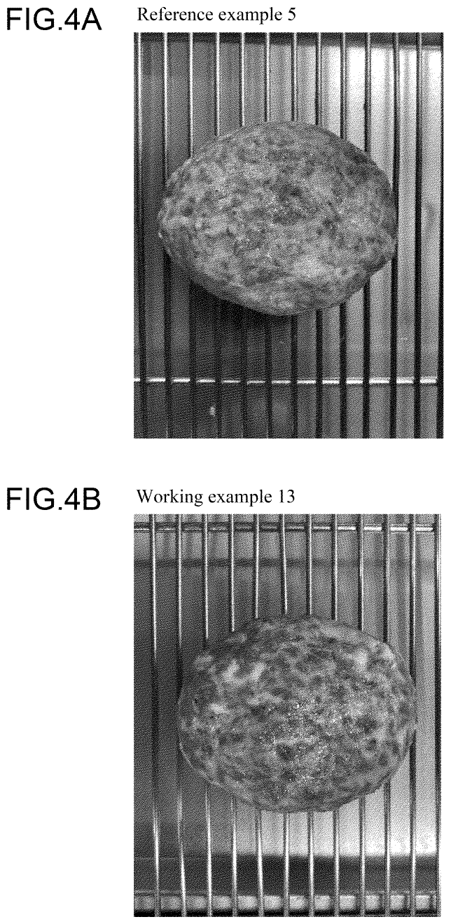

The criteria below were used to assess whether the oil-in-water emulsion composition resembles the spread of meat fat to provide a more meat-like outer appearance (physical appearance). FIGS. 4A and 4B illustrate outer appearances, as references, of soy meat patty of Reference Example 5 and Working Example 13.
∘ was assigned when the oil-in-water emulsion composition or rape seed oil resembled the spread of meat fat and provided a more patty-like outer appearance.
× was assigned when the oil-in-water emulsion composition or rape seed oil was kneaded into the dough and provided an outer appearance that is unappealing as a patty.

The results of the above assessment are as shown in Table 5.

TABLE 5

| | Working | Comparative | Comparative | Reference |
|---|---|---|---|---|
| | example 13 | example 1 | example 4 | example 5 |
| Juiciness | ⊚ | X | Δ | — |
| Firmness | ⊚ | ⊚ | Δ | X |
| Outer appearance | ◯ | X | X | X |
| before thermal | | | | |
| processing | | | | |

### (5) Evaluation of Plant-Based Block Meat

The plant-based block meat formulated with the oil-in-water type emulsion composition was prepared to assess the cross-sectional outer appearance under refrigeration, the cross-sectional appearance during thermal processing, and the seepage of oil.

The oil-in-water type emulsion compositions of Working Example 4 and Comparative Example 1 were adjusted to have a temperature of 20° C. and softened. 78 g of hydrated tissue wheat protein, 5 g of wheat gluten, 5 g of processed starch, and 2 g of other seasonings were thoroughly mixed to which 10 g of the softened oil-in-water type emulsion composition of the working or comparative example was roughly mixed to the extent that the oil-in-water type emulsion composition retains clusters, and the mixture was placed into a heat-resistant bag and deaerated. It was heated in boiling water for 60 minutes and then refrigerated overnight to serve it as a sample.

Reference Example 6 employed shortening in place of the one of the working or comparative examples and was used as a reference for evaluating them.

### [Cross-Sectional Outer Appearance Under Refrigeration]

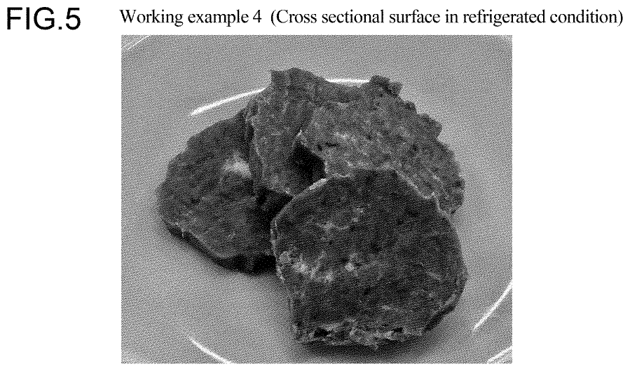

The refrigerated plant-based block meat was sliced into a 1 cm-wide portion whose cross-sectional outer appearance was evaluated based on the criteria as indicated below. The outer appearance of Working Example 4 is shown in FIG. 5 as a reference.
∘ was assigned when the oil-in-water type emulsion composition or shortening was roughly kneaded and provided a marbled outer appearance.
× was assigned when the oil-in-water type emulsion composition or shortening kneaded in a dough hardened and crumbled upon slicing.

### [Cross-Sectional Outer Appearance During Thermal Processing]

The refrigerated plant-based block meat was sliced into a 1 cm-wide portion, and both sides of it were fried in a frying pan, and their ross-sectional outer appearances were then evaluated using the following criteria in which:
∘ was assigned when the shape was partially retained after heat application; and
× was assigned when the oil was completely melted out and formed voids in the dough.

### [Oil Seepage During Thermal Processing]

The refrigerated plant-based block meat was sliced into a 1 cm-wide portion, and both sides of it were fried in a frying pan, and the manner of oil seepage was then evaluated using the following criteria in which:
∘ was assigned when the shape was retained like a real meat and the oil was partially seeped out; and
× was assigned when no oil was seeped out or the oil was completely melted out.

The results of the above evaluation are as shown in Table 6.

TABLE 6

| | Working | Comparative | Reference |
|---|---|---|---|
| | example 4 | example 1 | example 6 |
| Cross sectional outer appearance | ◯ | ◯ | X |
| in refrigerated condition | | | |
| Cross sectional outer appearance | ◯ | ◯ | X |
| during thermal processing | | | |
| Oil seepage during thermal | ◯ | X | X |
| processing | | | |

### (6) Evaluation of Plant-Based Block Meat Using Transglutaminase

The plant-based block meat, formulated with the oil-in-water emulsion composition, was evaluated for cohesiveness through a transglutaminase enzyme reaction and assessed for firmness.

The oil-in-water type emulsion compositions of Working Example 4 was adjusted to have a temperature of 20° C. and softened. 76 g of hydrated tissue soy protein, 4 g of processed starch, 4 g of transglutaminase pharmaceutical formulation (KS-CT manufactured by Ajinomoto Co., Inc.), and 1 g of other seasonings were crushed and stirred by a food processor, and then finally 15 g of the oil-in-water type emulsion composition of Working Example 4 was added thereto and uniformly mixed. The mixture was placed into a heat-resistant bag, deaerated, and stored at 5° C. overnight to allow for enzymic reaction. It was then heated in boiling water for 60 minutes, and then refrigerated to serve it as a sample.

Reference Example 7 employed rape seed oil in place of the oil-in-water type emulsion composition of Working Example 4 and was used as a reference for evaluating them, and their cohesiveness and firmness were evaluated using a reference product where no fat/oil was added.

### [Cohesiveness/Firmness]

The plant-based block meat controlled to have a temperature at 20° C. was sliced into a 1 cm-wide portion and its cohesiveness and firmness were sensorially evaluated against a reference product where no fat/oil was added.
∘ was assigned when the cohesiveness and firmness were realistic compared to the product where no fat/oil was added.
× was assigned when it had a brittle texture and was soft and collapsable compared to the product where no fat/oil was added.

### [Firmness]

The plant-based block meat was sliced into a size of 20 mm in length, 20 mm in width, and 10 mm in height, and the firmness at break was measured using a texture analyzer EZ-SX200N (manufactured by Shimadzu Corporation). A sample whose temperature was controlled at 20° C. underwent measurement at the center using a 40 mm diameter wedge jig to measure the load (N) under the condition of 0.5 mm/sec.

The results are as shown in Table 7.

The block meat of Reference Example 7 to which rape seed oil was added not only inhibited the transglutaminase reaction and softened the product but also exhibited a brittle physical texture. Meanwhile, the inventive product incorporating the composition of Working Example 4 demonstrated firmness similar to, and cohesiveness on par with, block meat prepared without the addition of oil or fat.

TABLE 7

| | Working | Reference | |
|---|---|---|---|
| | example 4 | example 7 | No added fats |
| Cohesiveness and firmness | ◯ | X | — |
| Firmness measurement (N) | 7.4 | 3.8 | 9.6 |

1. An oil-in-water type emulsion composition comprising:
an oil/fat;
a methylcellulose having a kinematic viscosity of 4,000 mm²/s or higher in a 2 mass % aqueous solution at 20° C.; and
an emulsification agent,
wherein the oil/fat is contained therein in an amount of 63 to 85 mass %.

2. The oil-in-water type emulsion composition according to claim 1, wherein the methylcellulose is contained therein in an amount of 0.5 to 10 mass %.

3. The oil-in-water type emulsion composition according to claim 1, wherein the oil/fat contains a solid fat content of 10 to 90% at 10° C.

4. The oil-in-water type emulsion composition according to claim 1, wherein the emulsification agent comprises at least one selected from a sorbitan fatty acid ester, a monoglycerin fatty acid ester, a polyglycerin fatty acid ester, and a sucrose fatty acid ester.

5. The oil-in-water type emulsion composition according to claim 1, wherein a weight ratio of the methylcellulose to the emulsification agent is 0.1 to 3.5.

6. The oil-in-water type emulsion composition according to claim 1, wherein the composition has a median diameter of 1.0 to 4.0 μm.

7. The oil-in-water type emulsion composition according to claim 1, wherein the composition has plasticity.

8. A method for producing the oil-in-water type emulsion composition according to claim 1, comprising the steps of:
dispersing the methylcellulose in an insoluble state into an aqueous phase at 40° C. or higher of the oil-in-water type emulsion composition that is in a process of being produced;
charging the oil-in-water type emulsion composition whose methylcellulose is dispersed in the aqueous phase into a container; and
cooling the oil-in-water type emulsion composition after being charged thereinto to dissolve the methylcellulose.

9. A food product comprising the oil-in-water type emulsion composition according to claim 1.
